(19) United States
(12) Patent Application Publication
(10) Pub. No.: US 2025/0309446 A1
(43) Pub. Date: Oct. 2, 2025

(54) BATTERY MODULE FOR A CONTROL UNIT OF AN ELECTRICAL CIRCUIT BREAKER, CONTROL UNIT AND ASSOCIATED ELECTRICAL CIRCUIT BREAKER

(71) Applicant: Schneider Electric Industries SAS, Rueil-Malmaison (FR)

(72) Inventors: Thomas Bianchi, Grenoble (FR); Patrick Prieur, Claix (FR); Yves Leveque, Voiron (FR); Jean-Marc Lichere, Fontaine Les Dijon (FR)

(73) Assignee: Schneider Electric Industries SAS, Rueil-Malmaison (FR)

(21) Appl. No.: 19/091,188

(22) Filed: Mar. 26, 2025

(30) Foreign Application Priority Data
Mar. 28, 2024 (FR) 2403191

(51) Int. Cl. H01M 50/251; H01H 9/02; H01M 10/42; H01M 50/202; H01M 50/271; H01M 50/296

(52) U.S. Cl. CPC H01M 50/251; H01H 9/02; H01M 10/425; H01M 50/202; H01M 50/271; H01M 50/296; H01M 2220/10

(57) ABSTRACT

This battery module (200) is configured to be inserted into a battery housing (201) opening onto a front face (22) of a control unit (20) of an electrical circuit breaker. The battery module comprises an envelope (210) with a proximal wall (214), which is generally orthogonal to a main axis (A214), and a peripheral wall (216), which extends from the proximal wall and presents a continuous contour around the main axis, the proximal wall and the peripheral wall together delimiting a cavity (211) for receiving a battery (212). The battery module comprises a conductive element (220B), which is partially received in the cavity and is configured to be connected to a pole of the battery. The proximal wall and the peripheral wall together form a continuous portion of the envelope that extends from the proximal wall and according to the main axis, at a minimum distance (L240) greater than or equal to 14 mm.

The present invention relates to a battery module for a control unit of an electrical circuit breaker. The invention also relates to a control unit including such a battery module, as well as an electrical circuit breaker including such a control unit.

It is known, particularly from EP-0 843 332-A1, electrical circuit breakers including a breaker unit and an electronic control unit. Such a control unit is typically configured to measure, in real-time, the operating state of the circuit breaker and to command the opening of the breaker unit in case of a malfunction of the circuit breaker. The control unit is reversibly received in a housing provided in the breaker unit and is located on a front face of the circuit breaker, so that a user can read and/or adjust certain operating parameters of the electrical circuit breaker. The control unit is removable, so that a user can replace the control unit in case of malfunction, without having to disconnect the breaker unit from the rest of the electrical installation.

According to the applications, the electrical circuit breaker operates under voltages of several hundred or even thousands of Volts, and under currents up to several thousand Amperes. The electrical circuit breaker in general, and the control unit in particular, must present sufficient electrical isolation to ensure the safety of people. For example, the IEC 947-1:2019 standard—tables 13 and 15—defines isolation classes, which correspond to minimum distances to be respected between electrified points—or likely to be electrified—and the user. The isolation distances depend, in particular, on the isolation class sought, and the electrical voltage under which the electrical circuit breaker operates. In the context of the present description, two main voltage ranges are considered, with a first range corresponding to a voltage less than or equal to 690 V, and a second range corresponding to a voltage strictly greater than 690 V. For a voltage greater than 690 V, class 1 isolation requires a clearance greater than 7 mm, and creepage distances greater than 10 mm. Class 2 isolation doubles these distances. For a voltage less than 690 V, class 2 isolation requires a clearance greater than 10 mm.

EP 3 290 935-A1 describes, for example, a control unit comprising a casing made of an insulating material, in which several components are received, such as a printed circuit board, voltage division components, etc. A power supply module is generally provided to supply the control unit when the circuit breaker is powered up. A battery is generally provided and received in a housing provided in the casing, in particular to allow the backup of various data during the triggering of the circuit breaker or when the circuit breaker is not powered up.

However, this battery must be changed periodically. With prior art electrical circuit breakers, it is necessary to remove the control unit from the breaker unit, which requires the user to have specific authorization and to interrupt the service of the electrical installation, making the replacement of a battery, an apparently simple task, a heavy and complex operation. Thus, it is sought to be able to change the battery from the front, without interruption of service, while ensuring the safety of people.

The invention particularly aims to address these needs by proposing a battery module that can be installed from the front on a control unit, while ensuring the protection of people.

To this end, the invention relates to a battery module for a control unit of an electrical circuit breaker, the battery module being configured to be inserted into an associated battery housing of the control unit, the housing opening onto a front face of the control unit and presenting an elongated shape according to a depth axis orthogonal to the front face, the control unit comprising two electrical contact pads arranged in a bottom of the housing, wherein:
the battery module comprises:
   an envelope, which comprises a proximal wall, which is generally orthogonal to a main axis, and a peripheral wall, which extends in projection from the proximal wall and which presents a continuous contour around the main axis, the proximal wall and the peripheral wall together delimiting a cavity of the envelope, the cavity being configured to receive an electric battery presenting two electric poles, the cavity opening from the envelope through a distal opening, which is located opposite the proximal wall according to the main axis,
   a cover, which is movable relative to the envelope between an open position and a closed position, in which the cover at least partially closes the cavity, the cover in the closed position being configured to hold the electric battery in the cavity, the battery module being then in a closed configuration,
   two conductive elements, each comprising an input tab, which is configured to be connected to a respective pole of the battery, and an output tab, which is configured to be connected to a respective electrical contact pad of the control unit when the battery module is in a closed configuration and is received in the corresponding housing, in an assembled configuration of the battery module to the control unit,
the proximal wall and the peripheral wall together form a continuous portion of the envelope, the continuous portion extending to a minimum distance from the proximal wall, the minimum distance being measured according to the main axis and being greater than or equal to 14 mm.

Thanks to the invention, it is ensured that a class 2 isolation distance according to the IEC947-1:2019 standard is always respected, regardless of the position of the battery module during its assembly to the control unit, in other words, both in the assembled configuration of the control unit and during the insertion of the battery module into the housing of the control unit. Thus, even when the housing opens onto the front face of the battery module, the replacement of the battery module is possible, from the front, in other words, without having to displace the battery module relative to the rest of the electrical circuit breaker.

According to advantageous but non-mandatory aspects of the invention, such a battery module may incorporate one or more of the following features taken in isolation or in any technically permissible combination:
The cover is articulated in rotation, relative to the envelope, around a hinge axis, between the open position and the closed position.
The battery module is configured to receive a battery presenting two poles located on opposite faces of the battery,
whereas the two conductive elements include a first element, which is carried by the cover, and a second element, which is carried by the envelope, that the output tabs each comprise a terminal portion presenting generally a straight blade shape,
and whereas, when the battery module is in a closed configuration, the two terminal portions open from the cavity through passages, which are provided in the cover, the two terminal portions extending parallel to the main axis and being offset relative to each other according to a transverse axis, which is orthogonal to the main axis.
When the battery module is in a closed configuration, the terminal portions are geometrically carried by a same connection plane, which is parallel to the main axis and parallel to the transverse axis,
whereas the cover comprises two extensions, each extension being associated with a respective passage,
whereas each extension provides a conduit, which extends from the associated passage parallel to the main axis when the battery module is in a closed configuration, the terminal portion opening through the considered passage being at least partially received in the associated conduit,
and whereas the two conduits are open according to a same connection direction, the connection direction being orthogonal to the connection plane, so as to allow an electrical connection on each of the terminal portions according to the connection direction.
Each terminal portion comprises an end, the ends of the terminal portions being aligned, relative to each other, according to the transverse axis,
whereas each extension presents a lug, which extends in projection, from the rest of the extension, within the corresponding conduit, each lug being interposed between the extension and the corresponding terminal portion according to the connection direction, each lug taking support against the corresponding terminal portion, and whereas the lugs are aligned according to the transverse axis.
Each terminal portion comprises an end presenting a terminal bulge, which is provided in projection relative to the rest of the corresponding terminal portion and extends according to the connection direction, each terminal bulge being configured to take support on the associated contact pad,
whereas each extension presents a terminal protrusion, which is provided in projection relative to the rest of the corresponding extension according to the connection direction, each terminal protrusion being aligned, according to the main axis, with the terminal bulge of the corresponding terminal portion.

The invention also relates to a control unit for an electrical circuit breaker, the control unit comprising:
one example of the battery module as defined above, and
a casing, which is made of an insulating material and in which a housing for receiving the battery module is provided, the housing being provided recessed from the front plane and opening onto the front face according to the depth axis,
   wherein:
the control unit comprises two contact pads, which are arranged in a bottom of the housing,
the two output tabs are configured to be electrically connected to a respective contact pad when the control unit is in the assembled configuration.

### Advantageously:

The battery module is as defined above,
whereas the housing comprises a bottom wall, in which openings are provided, the contact pads being located on a side opposite the housing relative to the bottom wall,
and wheras, when the control unit is in the assembled configuration, each extension and the associated terminal portion pass through the corresponding opening, the terminal portion being in support against the corresponding contact pad.
The openings present an IP2x protection index such as defined in the IEC 60529:2013 standard.
The battery module is such as defined above,
whereas each terminal protrusion is configured to, during an insertion movement of the battery module into the battery housing, take support on a contour of the corresponding opening, so as to guide each extension and the associated terminal portion when passing through the opening and to prevent the terminal bulge of the considered terminal portion from hitting the contour of the opening.

The invention also relates to an electrical circuit breaker, comprising:
a breaker unit, comprising at least one actuator and a breaker device triggerable by means of the actuator,
one example of the control unit as defined above,
   wherein:
the breaker unit provides a receptacle, which opens onto a front face of the breaker unit,
the control unit is received in the receptacle of the breaker unit in an assembled configuration of the electrical circuit breaker, where the control unit is configured to control the actuator, so as to trigger the breaker device.

The invention will be better understood, and other advantages thereof will appear more clearly in the light of the following description of one embodiment of a battery module and a control unit and a circuit breaker, in accordance with its principle, given solely by way of example and made with reference to the appended drawings, in which:

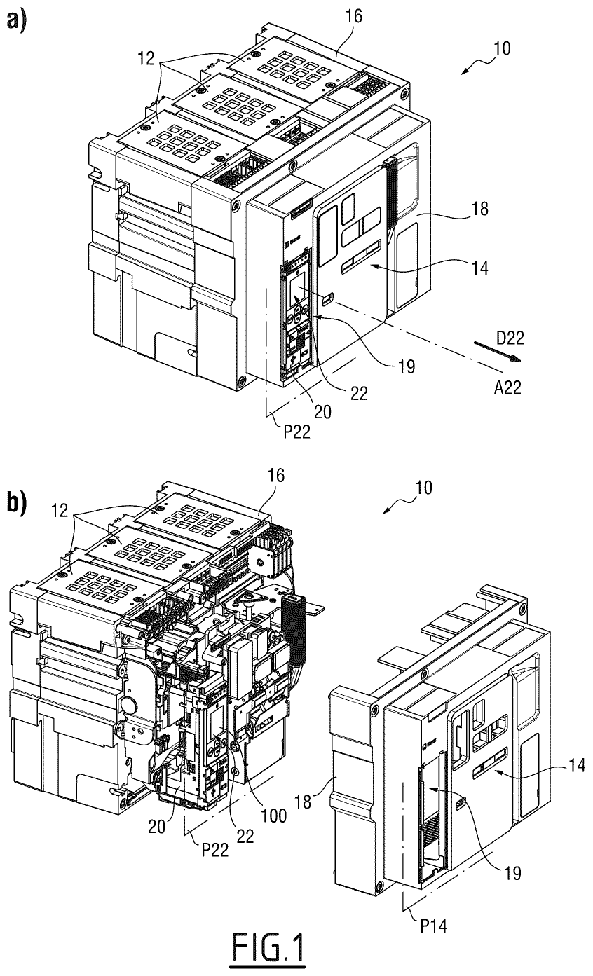

FIG. 1 respectively represents, in two inserts a) and b), a perspective view and a partially exploded perspective view of an electrical circuit breaker in accordance with the invention, the electrical circuit breaker comprising a control unit, also in accordance with the invention;

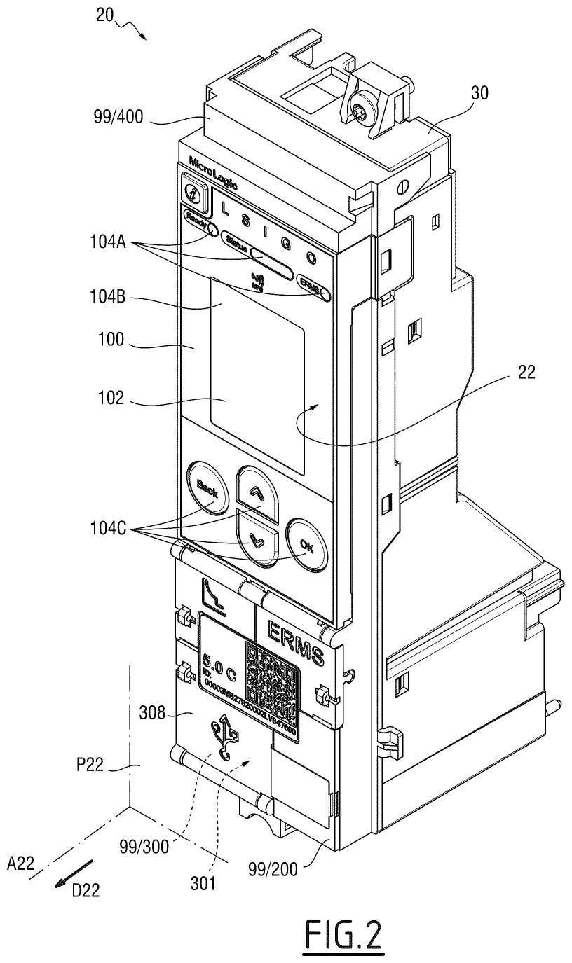

FIG. 2 is a perspective view of the control unit of FIG. 1;

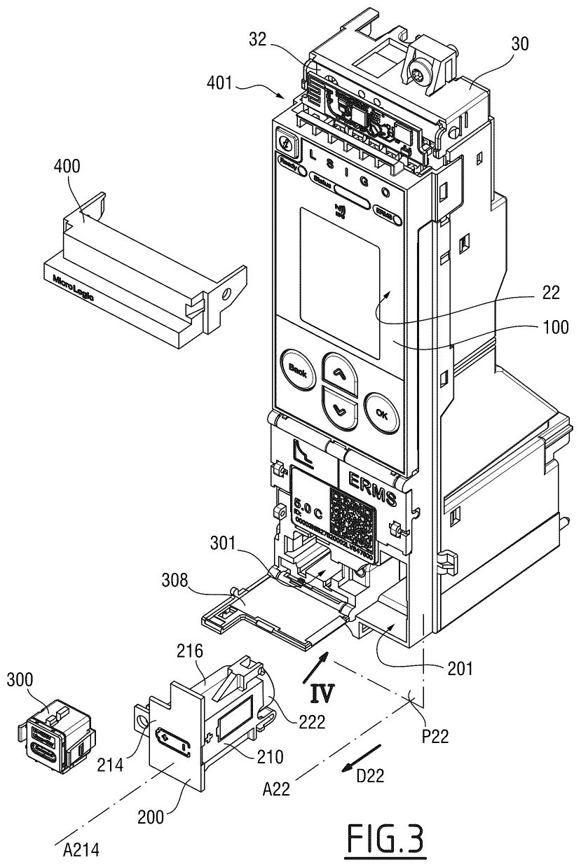

FIG. 3 is a partially exploded perspective view of the control unit of FIG. 1, the control unit comprising a battery module in accordance with the invention;

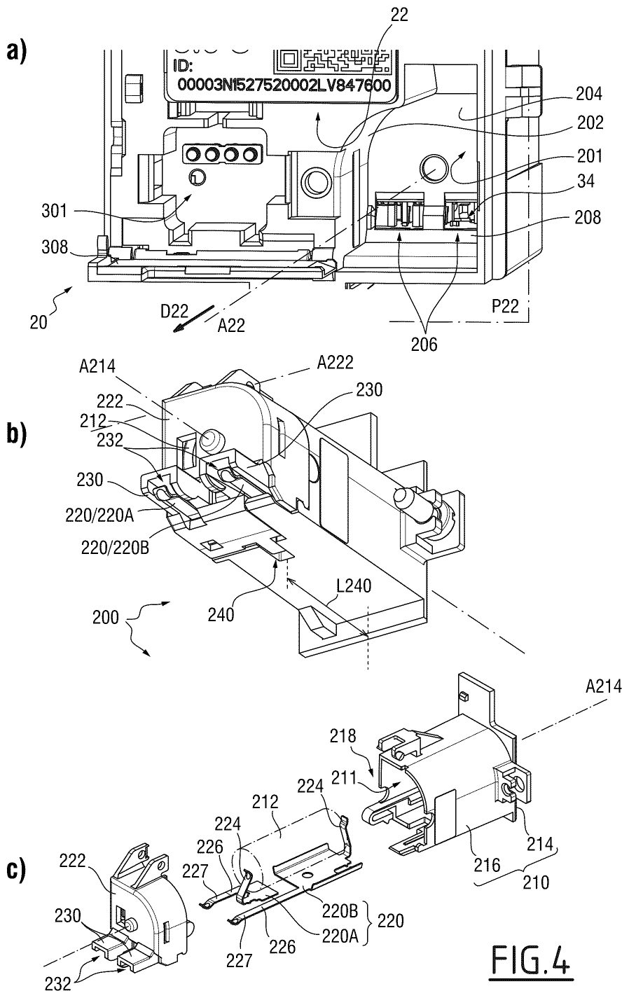

FIG. 4 respectively represents, in three inserts a), b), and c), a larger scale view of the control unit according to the arrow IV in FIG. 3, and the battery module of FIG. 3, the battery module being represented in perspective and in exploded perspective in inserts b) and c);

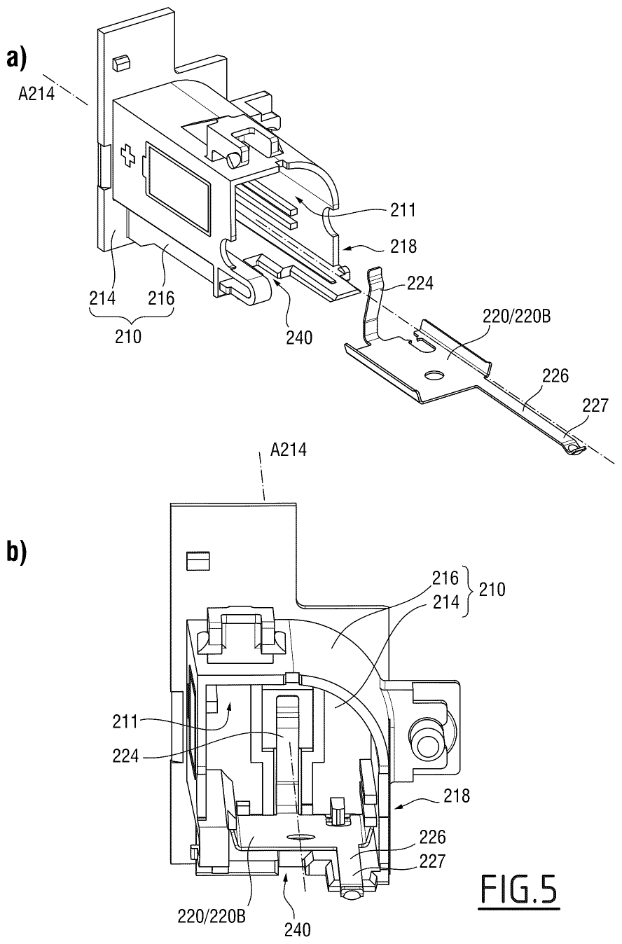

FIG. 5 represents, in two inserts a) and b), certain elements of the battery module of FIG. 3 in exploded perspective and in perspective;

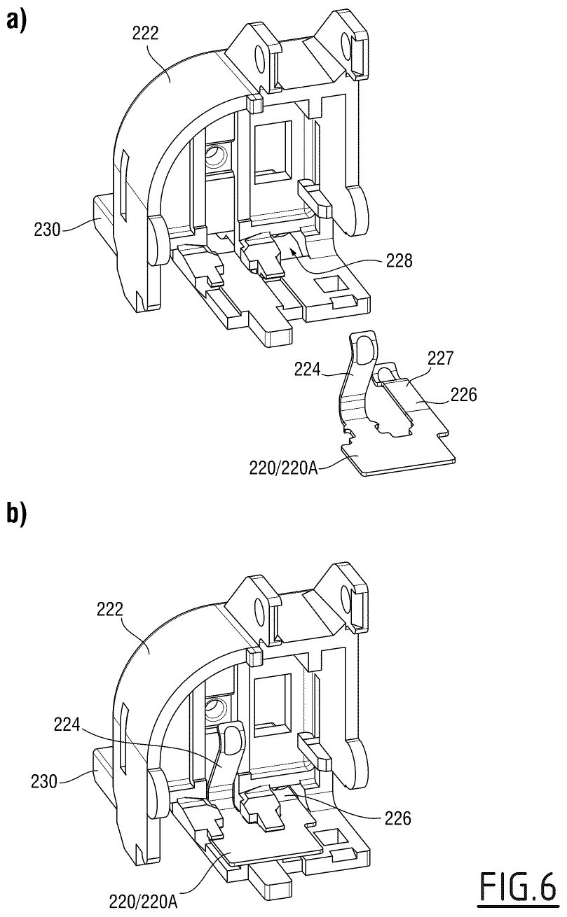

FIG. 6 represents, in two inserts a) and b), certain elements of the battery module of FIG. 3 in exploded perspective and in perspective;

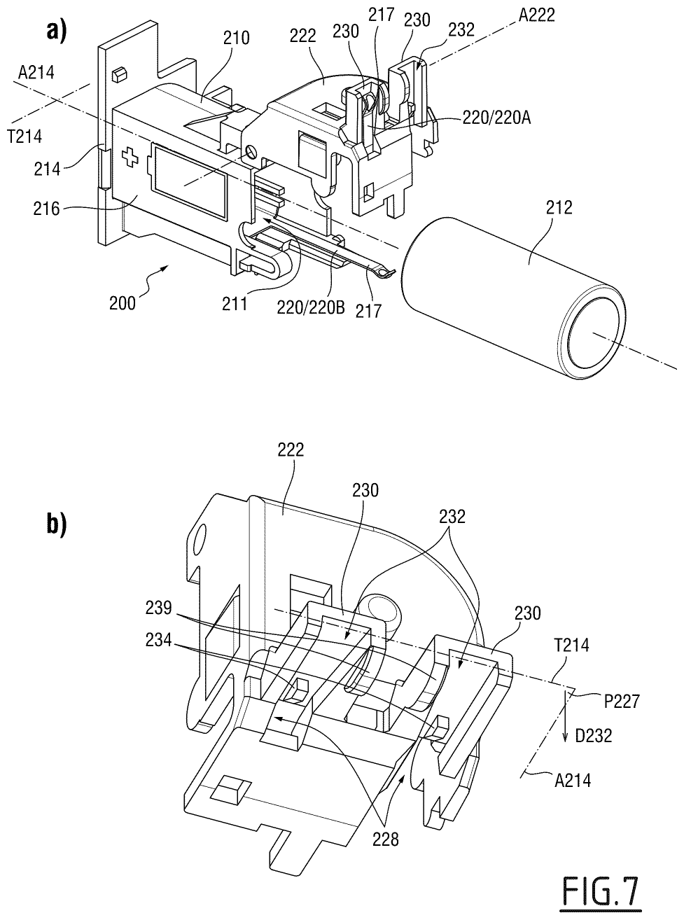

FIG. 7 represents, in two inserts a) and b), a perspective view of the battery module of FIG. 3 in an open configuration, and a perspective view of a cover of the battery module;

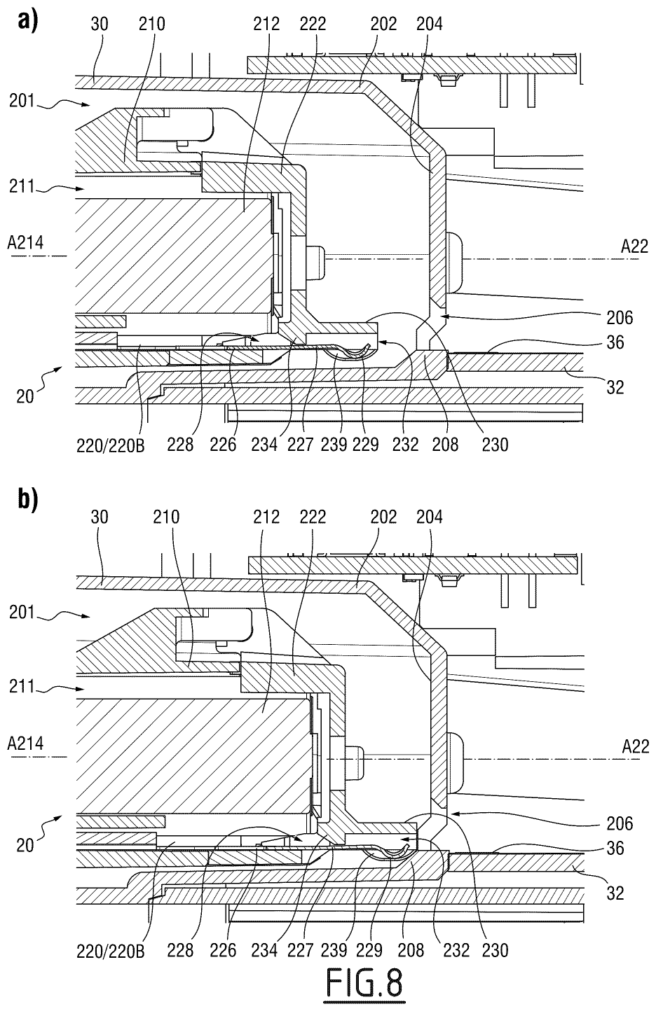

FIG. 8 represents, in two inserts a) and b), a section of the control unit in two successive intermediate configurations during the assembly of the battery module to the rest of the control unit;

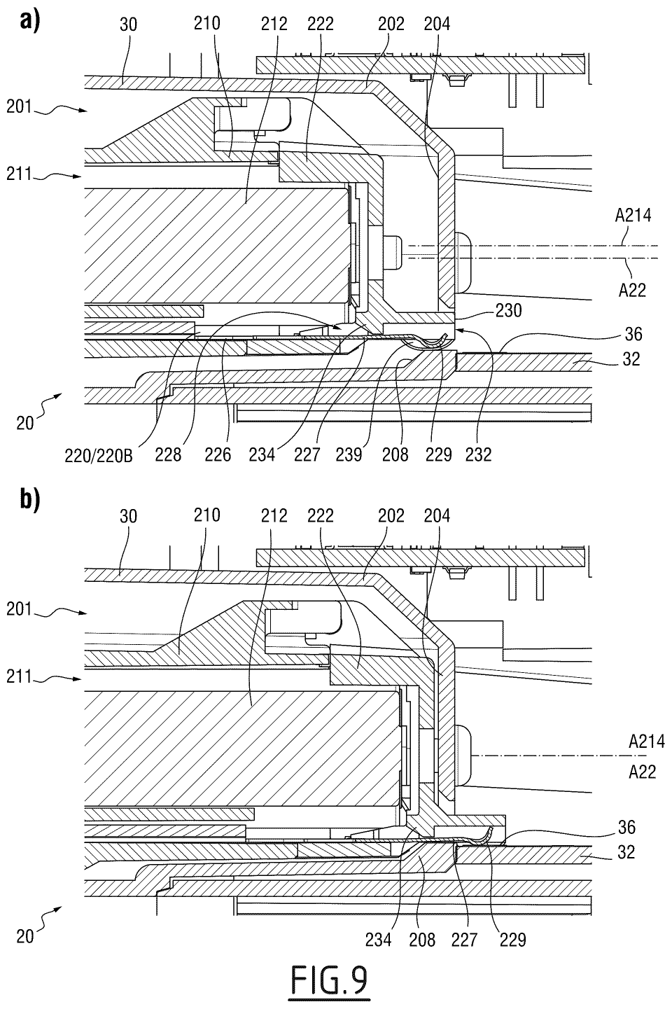

FIG. 9 respectively represents, in two inserts a) and b), a section of the control unit in a third intermediate configuration and in an assembled configuration during the assembly of the battery module to the rest of the control unit;

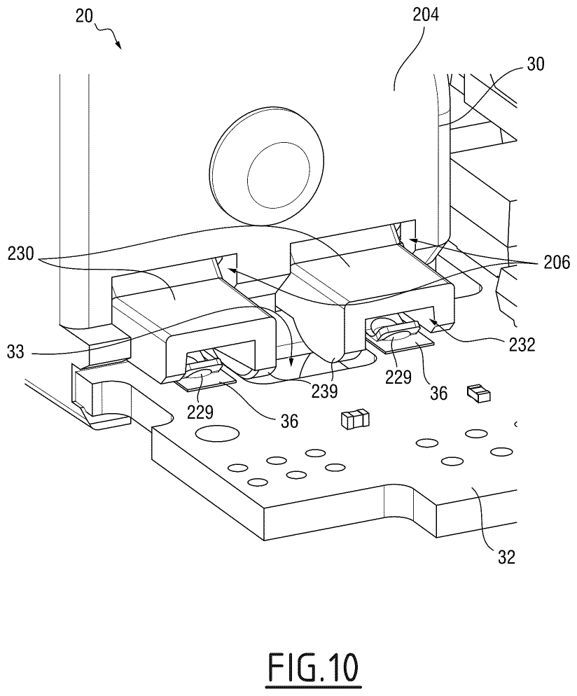

FIG. 10 is a perspective view of a detail of the control unit in an assembled configuration, some pieces being hidden.

An electrical circuit breaker 10 is represented in FIG. 1. The electrical circuit breaker 10, also simply called circuit breaker 10, is here a multipole circuit breaker, in particular a three pole circuit breaker. The number of poles of the circuit breaker 10 is not limiting. In a known manner, a multipole electrical circuit breaker includes, for each electrical pole, input and output power terminals, which are respectively connected or electrically isolated from each other by a breaker device of the circuit breaker. The breaker device comprises, for example, separable movable contacts, which are received in a breaker chamber of the electrical circuit breaker 10 and the movements of which are controlled by an actuator. Thus, the breaker device is triggerable by the actuator. The breaker chambers are here materialized by three grids 12 visible on an upper face of the circuit breaker 10, the other elements of the breaker device not being represented.

The electrical circuit breaker 10 is intended to be used within an electrical installation, for example, to control the power supply of a machine tool. In a normal use configuration, the electrical circuit breaker 10 is generally placed within an electrical cabinet, the electrical circuit breaker 10 presenting a frontal face 14, which is oriented toward the user standing in front of the electrical cabinet. The electrical cabinet is not represented.

The electrical circuit breaker 10 comprises a breaker unit 16, which, in particular, includes each of the breaker chambers, as well as the breaker device and the associated actuator.

The electrical circuit breaker 10 advantageously comprises a cover 18, which is removable from the breaker unit 16. The cover 18 is made of an electrically insulating material and extends generally according to a frontal plane P14, which defines a portion of the frontal face 14 of the electrical circuit breaker 10, and by extension of the breaker unit 16. The cover 18 thus serves to protect the user from the circuit breaker 10. In FIG. 1 a), the cover 18 is represented assembled to the breaker unit 16, which corresponds to a normal use configuration of the circuit breaker 10. In FIG. 1 b), the cover 18 is spaced away from the breaker unit 16, this configuration being found, for example, during maintenance of the breaker unit 16.

The electrical circuit breaker 10 also comprises a control unit 20. The control unit 20 is configured to analyze the states of the breaker unit 16 and is configured to trigger the actuator based on the results of these analyses, thus separating the separable contacts.

The control unit 20 comprises a front face 22, the front face 22 presents a generally flat shape and is geometrically carried by a front plane P22, which is orthogonal to a depth axis A22 of the control unit 20. The front face 22 is oriented toward the user when the control unit 20 is in a normal use configuration. The front face 22 thus defines a forward direction D22, which is parallel to the depth axis A22. The forward direction D22 is represented by an arrow. The notions of directions such as “forward,” “backward,” “up,” “down,” etc., are defined in relation to the elements such as represented in the drawings, knowing that it may be otherwise in reality.

The cover 18 comprises a window 19, through which the front face 22 of the breaker unit 20 is visible. The window 19 is preferably closed by a transparent flap. The flap is not represented.

The control unit 20 is assembled to the breaker unit 16 in a reversible manner. In the example of FIGS. 1a) and 1b), the control unit 20 is represented in an assembled configuration to the breaker unit 16. The control unit 20 is represented in isolation in FIG. 2.

The breaker unit 16 provides a receptacle, which opens onto a frontal face 14 of the breaker unit 16 and in which the control unit 20 is received, so that the front face 22 of the control unit 20 in an assembled configuration is substantially aligned with the frontal face 14 of the breaker unit 16, as illustrated, in particular, in FIG. 1 a). The receptacle is not represented.

The control unit 20 is now described, with reference to FIGS. 2 and 3.

The control unit 20 comprises a casing 30, which is made of an insulating material, and which forms a receiving volume for various components of the control unit 20. The casing 30, in particular, houses a printed circuit board 32, which is partially visible in FIG. 3. The printed circuit board 32 comprises a printed circuit and several electronic components such as a microprocessor, etc.

In the illustrated example, the printed circuit board 32 comprises several portions, which are, here, connected to each other by communication buses. The communication buses are not represented. Optionally, one or more portions of the printed circuit board 32 are flexible. Alternatively, the printed circuit board 32 includes several portions that are not connected to each other by communication buses. Alternatively, the printed circuit board is in one piece.

The casing 30 includes a front sub-assembly 100. By extension, the sub-assembly 100 belongs to the control unit 20. The front sub-assembly 100 comprises a central portion 102, which is generally flat, which presents a front side 102A and a rear side 102B opposite the front side 102A. The central portion 102 is here configured to receive at least one human machine interface element 104. The front side 102A of the central portion 102 is preferably oriented according to the forward direction D22. A human machine interface is also referred to by its acronym HMI. The human machine interface elements 104 are also simply noted as “HMI elements” 104. In the illustrated example, the central portion 102 comprises several HMI elements 104. The HMI elements 104 here include three indicator lights 104A, a transparent portion 104B, through which a screen can be observed, and four buttons 104C. These examples are not limiting, the type, number, and arrangement of the HMI elements 104 can be changed during the design of the front sub-assembly 100.

The front sub-assembly 100 is assembled to the rest of the control unit 20, in particular to the casing 30, in a reversible manner. It is thus possible to replace the front sub-assembly 100 in case of malfunction. The central portion 102 thus forms a portion of the front face 22 of the control unit 120.

The casing 30 comprises at least one housing 98, here three housings, each housing being provided recessed from the front plane P22 and opening onto the front face 22.

The control unit 20 also comprises at least one functional module 99, here three functional modules 99, each housing being associated with a respective functional module. Each functional module 99 is thus configured to be reversibly received in the associated housing, the functional module 99 under consideration, being in an assembled configuration.

Preferably, the control unit 20 comprises several functional modules 99. In the illustrated example, the control unit 20 comprises three functional modules 99, which are different from each other, and which include a first module, which is here a module designed to receive a battery called a battery module 200, a second module, which is here a wired connection module 300, and a third module, which is here a wireless communication module 400. Each functional module 99 is associated with a respective housing 98. Each functional module 99 is configured to be reversibly received in the associated housing 98, the functional module 99 being then in an assembled configuration. In the illustrated example, each functional module 99 is configured to be inserted into the corresponding housing 98 according to an insertion movement, which is a movement in translation parallel to the depth axis A22 and oriented according to a rearward direction, in other words, in a direction opposite to the forward direction D22.

In FIG. 3, the control unit 20 is represented in a partially exploded perspective, the battery module 200, the connection module 300, and the communication module 400 being represented spaced away from the casing. The battery module 200 is thus associated with a battery housing 201, while the connection module 300 is associated with a connection housing 301, and the communication module 400 is associated with a housing arranged at the edge of the front face 22 and named frontal housing 401. In the illustrated example, the control unit 20 comprises a cover 308, which is articulated relative to the casing, and which closes the connection housing 301. The cover 308 is represented in a closed position in FIG. 2, and in an open position in FIG. 3.

The battery module 200 and the battery housing 201 are now described.

With reference to FIG. 4 a), the battery housing 201 presents a substantially cylindrical shape according to an axis parallel to the depth axis A22. The battery housing 201 is here delimited by a peripheral wall 202 and by a bottom wall 204. The bottom wall 204 delimits the battery housing 201 on the rear side and is part of the casing 30. The bottom wall 204 is thus arranged, recessed relative to the front plane P22 according to the forward direction D22 and opens onto the front plane P22.

The battery housing 201 comprises openings 206, which are provided in the bottom wall 204 and which open into the battery housing 201. A portion of the printed circuit board 32 is located on the rear side of the bottom wall and comprises a connection zone 34, the connection zone 34 comprising at least one contact pad 36. Each contact pad 36 comprises a substantially flat conductive element located on the surface of the printed circuit board 32, each contact pad 36 being able to be electrically connected to a respective complementary connector 220 belonging to the battery module 200, each complementary connector 220 coming into contact with the corresponding contact pad 36. Advantageously, the contact pads 36 are part of the printed circuit of the printed circuit board 32, in other words, they are manufactured at the same time as the printed circuit board 32.

In the illustrated example, the connection zone 34 comprises two contact pads 36, which are located on the rear side of the bottom wall 204 and which are accessible from the battery housing 201 through the openings 206. The two contact pads 36, and by first extension the connection zone 34, are thus associated with the battery housing 201.

Each opening 206 presents a profile with an inscribed circle of diameter strictly less than 4 mm, preferably less than 3.9 mm, in order to comply with an IP2x protection index as defined in the IEC 60529:2013 standard. This thus reduces the risk of accidental introduction of objects through the openings, reducing the risk of electrical accidents.

Each contact pad 36 of the associated connection zone 34 is located, recessed from the front plane P22 and is spaced away from the front plane P22 by a distance, measured according to the depth axis A22, greater than a predetermined first threshold S1. The first threshold S1 is chosen so that a clearance distance between each contact pad 36 and the front plane P22 is greater than a class 2 isolation distance under a voltage greater than 690 V, the clearance distance and the class 2 isolation distance being according to the IEC947-1:2019 standard. Schematically, the clearance distance between two points is the shortest path between these two points, while bypassing any obstacles.

Preferably, the first threshold S1 is greater than or equal to 14 mm. Preferably, a clearance distance between the rear side of the bottom wall 204 and the front plane P22 is greater than the first threshold S1. This ensures a minimum distance between all electrified elements located on the rear side of the bottom wall 204 and the front face 22 of the control unit 20, which improves the safety of use.

The battery module 200 comprises an envelope 210, which is made of an electrically insulating material, and which delimits a cavity 211. The cavity 211 is configured to receive an electric battery 212 presenting two electric poles. The electric battery 212 is here a cylindrical battery, the two electric poles of which are located on opposite faces. The battery 212 is represented schematically in dashed lines in FIG. 4 c). The principles of the invention can naturally be transposed to other types of batteries.

The envelope 210 comprises a proximal wall 214, which is generally orthogonal to a main axis A214, and a peripheral wall 216, which extends in projection from the proximal wall and presents a continuous contour around the main axis A214, the proximal wall 214 and the peripheral wall 216 together delimiting the cavity 211. Once the battery module 200 is received in the battery housing 201 in an assembled configuration, the main axis A214 is substantially parallel to the depth axis A22. The cavity 211 opens from the envelope 210 through a distal opening 218, which is located opposite the proximal wall 214 according to the main axis A214.

When the battery module 200 is received in the battery housing 201, the envelope 210 at least partially closes the battery housing 201, so that a creepage distance from each contact pad 36 to the front plane P22 is greater than a class 2 isolation distance under a voltage greater than 690 V, the creepage distance being according to the IEC 947-1:2019 standard.

When the battery module 200 is in an assembled configuration, the distal opening 218 is advantageously oriented toward the corresponding connection zone 34, the cavity 211 masking, toward the front, the contact pads 36, so that a creepage distance from each contact pad 36 to the front plane P22 is greater than a predetermined second threshold S2, the second threshold S2 being greater than the first threshold S1. In a simplified manner, the creepage distance between two points is the minimum distance between these two points by traveling along the surface of the material, air gaps less than 1.5 mm can nevertheless be crossed in the air. Advantageously, the second threshold S2 is greater than a class 2 isolation distance as defined in the IEC 947-1:2019 standard. Preferably, the second threshold S2 is equal to 20 mm.

The battery module 200 comprises, in addition to the insulating envelope 210, at least one complementary contact 220, which is made of metal, which is partially received in the cavity 211 and which protrudes outside the envelope 210 through the distal opening 218. Each complementary contact 220 being configured to be reversibly connected to a respective contact pad 36 of the corresponding housing when the first module 200 is in an assembled configuration. Thus, the presence of electrical contacts, and more generally of any other electrical or electronic device received in the cavity, has no impact on the level of protection in terms of clearance distance or creepage distances.

In the illustrated example, the battery module 200 comprises two complementary contacts 220, which connect the poles of the battery 212 to the contact pads 36 associated with the first battery housing 201. Advantageously, the battery module 200 also comprises a cover 222, which is movable relative to the envelope 210 between an open position and a closed position, in which the cover 222 at least partially closes the cavity 211, the cover 222 in the closed position being configured to hold the electric battery 212 in the cavity 211, the battery module 200 being then in a closed configuration.

The complementary contacts 220 include here a first conductive element 220A and a second conductive element 220B, which are formed by cutting and folding a metal sheet. The first conductive element 220A and the second conductive element 220B are visible in FIG. 4 b).

The first conductive element 220A is here carried by the cover 222, while the second conductive element 220B is carried by the envelope 210.

The two conductive elements 220A and 220B each comprise an input tab 224, which is configured to be connected to a respective pole of the battery 212, and an output tab 226, which is configured to be connected to a respective electrical contact pad 36 of the battery housing when the battery module is in a closed configuration and is received in the corresponding housing, in an assembled configuration of the battery module to the control unit, as represented in FIG. 5 b). The output tab 226 here comprises a terminal portion 227 which here presents a straight blade shape. When the battery module 200 is in a closed configuration, the terminal portions 227 are geometrically carried by a same connection plane P227, which is parallel to the main axis A214 and parallel to the transverse axis T214.

When the battery module 200 is in a closed configuration, the two terminal portions 227 open from the cavity 211 through passages 228, which are provided in the cover 222. In the illustrated example, the two terminal portions 227 extend parallel to the main axis A214, the two terminal portions 227 being offset relative to each other according to a transverse axis T214, which is orthogonal to the main axis A214. Thus, the ends of the terminal portions 227 are aligned, relative to each other, according to the transverse axis T214.

Each terminal portion 227 advantageously ends with a terminal bulge 229. Each terminal bulge 229 is provided in projection relative to the rest of the corresponding terminal portion 227 and extends according to the connection direction D232. Each terminal bulge 229 is configured to press against the associated contact pad 36. Thus, the terminal bulges 229 are aligned, relative to each other, according to the transverse axis T214. The terminal portion 227 of each output tab 226 is advantageously elastically deformable, so as to ensure sufficient contact pressure between the terminal bulge 229 and the corresponding contact pad 36.

The cover 222 comprises two extensions 230, each extension 230 being associated with a respective passage 228 and extending in projection from the rest of the cover 222. Each extension 230 provides a conduit 232, which extends from the associated passage 228 parallel to the main axis A214 when the battery module 200 is in a closed configuration, each terminal portion 227 opening through the considered passage 228 being at least partially received in the associated conduit 232.

The two conduits 232 are open according to the same connection direction D232, the connection direction D232 being orthogonal to the connection plane P227, the two conduits 232 being open on the same side of the connection plane P227, so as to allow an electrical connection on each of the terminal portions 227 according to the connection direction D232. Each extension 230 thus protects the terminal portion 227 when the battery module 200 is removed from the control unit 20, for example, to avoid bending the terminal portions 227 inadvertently.

Each extension 230 presents a lug 234, which extends in projection, from the rest of the extension 230, within the corresponding conduit 232. Each lug 234 is thus interposed between the extension 230 and the corresponding terminal portion 227 according to the connection direction D232. The lugs 234 are aligned, relative to each other, according to the transverse axis T214. Each lug 234 thus presses against the corresponding terminal portion 227. Thus, for each terminal portion 227, a length between the free end of this terminal portion 227 and a support zone of the corresponding lug 234 on the terminal portion 227 is substantially the same. While the terminal portions 227 of the two output blades 226 present a different length from each other, the lugs 234 ensure that a pressure force of each terminal portion 227 on the corresponding contact pad 36 is substantially the same, thus offering good electrical contact, in a repeatable manner after each assembly of the battery module 200 to the rest of the control unit 20.

Advantageously, each extension 232 presents a terminal protrusion 239, which is provided in projection, relative to the rest of the corresponding extension 232 according to the connection direction D232, the terminal protrusion 239 being aligned, according to the main axis A214, with the corresponding terminal bulge 229. Each terminal protrusion 239 thus protects the corresponding terminal bulge 229 from inadvertent contact.

As illustrated in FIG. 7 a), the cover 222 is advantageously articulated in rotation relative to the envelope 210 around a hinge axis A222, between the open position and the closed position. The hinge axis A222 is here an axis parallel to the transverse axis T214. The cover 222 is thus considered not detachable. During the mounting of the battery module 200, the operator inserts the battery 212 into the cavity 211 of the envelope 201, of course respecting the direction of the poles, if necessary, then displaces the cover 222 to the closed position, ensuring contact between each input tab and the corresponding pole of the battery 212.

The proximal wall 214 and the peripheral wall 216 together form a continuous portion of the envelope 210, the continuous portion extending to a minimum distance from the proximal wall 214, the minimum distance being measured according to the main axis and being equal to 14 mm. In other words, the proximal wall 214 and the peripheral wall 216 do not present any opening, which is located less than 14 mm according to the main axis A214, connecting the cavity 211 to the outside of the envelope.

In the illustrated example, the envelope 210 presents a notch 240, which is provided in the peripheral wall 216 and which delimits a portion of the distal opening 218, as represented in FIG. 4 b). The notch 240 is used here during the assembly of the second conductive element 220B in the envelope 210. A bottom of the notch here forms the place, through which the cavity 211 opens from the envelope 210, closest to the proximal wall 214. A distance L240, measured parallel to the main axis A214, is defined between the bottom of the notch 240 and the proximal wall 214. The distance L240 is greater than 14 mm. The distance L240 is here equal to 20.8 mm.

A sequence of assembly of the battery module 200 to the rest of the control unit 20 is now described, with reference to FIGS. 8 to 10.

In FIG. 8 a), the battery module 200 is inserted into the battery housing 201, the main axis A214 being substantially aligned with the depth axis A22. The insertion movement is substantially a movement in translation of the battery module 200 toward the rear of the control unit 20.

As the insertion movement of the battery module 200 continues, the terminal protrusion 239 comes into contact with a portion of the contour of the opening 206. More precisely, the casing 30 advantageously comprises a ramp 208, which provides an inclined surface making a connection between the peripheral wall 202 and the opening 206 and which forms, by extension, a portion of the contour of the opening 206. The control unit 20 is then in the configuration of FIG. 8 b). It is understood that the terminal protrusion 239 prevents contact between the terminal portion 229 and the casing 30. This thus reduces the risk of snagging the terminal portions 227 on the casing 20.

As the insertion movement of the battery module 200 continues, each terminal protrusion 239 presses against the contour of the corresponding opening 206, in particular on the ramp 208 so as to guide each extension 230 and the associated terminal portion 227 during passage through the opening 206, thus preventing the terminal bulge 229 of the considered terminal portion 227 and/or the extension 230 from hitting the contour of the opening 206. The control unit 20 is then in the configuration of FIG. 9 a).

As the insertion movement of the battery module 200 continues, each terminal protrusion 239 is now on the rear side of the bottom wall 204 of the battery housing 201, as illustrated in FIG. 9 b) and in FIG. 10. The printed circuit board 32 presents a recess 33, in which the terminal protrusions 239 are received. Each terminal bulge 229 is pressed on the corresponding contact pad 36. Each terminal portion 227 is pinched between the corresponding lug 234 and the contour of the corresponding opening 206, the terminal portion being elastically deformed to ensure a satisfactory contact force between the terminal bulge 229 and the corresponding contact pad 36.

The embodiments and alternatives mentioned above can be combined with each other to generate new embodiments of the invention.

1. A battery module for a control unit of an electrical circuit breaker, the battery module being configured to be inserted into an associated battery housing of the control unit, the housing opening onto a front face of the control unit and presenting an elongated shape along a depth axis orthogonal to the front face, the control unit comprising two electrical contact pads arranged in a bottom of the housing, wherein:
the battery module comprises:
an envelope, which includes a proximal wall, which is generally orthogonal to a main axis, and a peripheral wall, which extends in projection from the proximal wall and which presents a continuous contour around the main axis, the proximal wall and the peripheral wall together delimiting a cavity of the envelope, the cavity being configured to receive a battery presenting two electric poles, the cavity opening from the envelope through a distal opening, which is located opposite the proximal wall according to the main axis,
a cover, which is movable relative to the envelope between an open position and a closed position, in which the cover at least partially closes the cavity, the cover in the closed position being configured to hold the battery in the cavity, the battery module being then in a closed configuration,
two conductive elements, each comprising an input tab, which is configured to be connected to a respective pole of the battery, and an output tab, which is configured to be connected to a respective electrical contact pad of the control unit when the battery module is in a closed configuration and is received in the corresponding housing, in an assembled configuration of the battery module to the control unit,
the proximal wall and the peripheral wall together form a continuous portion of the envelope, the continuous portion extending to a minimum distance from the proximal wall, the minimum distance being measured according to the main axis and being greater than or equal to 14 mm.

2. The battery module according to claim 1, wherein:
the cover is articulated in rotation, relative to the envelope, around a hinge axis, between the open position and the closed position.

3. The battery module according to claim 1,
wherein:
the battery module is configured to receive a battery presenting two poles located on opposite faces of the battery,
the two conductive elements include a first element, which is carried by the cover, and a second element, which is carried by the envelope,
the output tabs each comprise a terminal portion presenting generally a straight blade shape,
when the battery module is in a closed configuration, the two terminal portions open from the cavity through passages, which are provided in the cover, the two terminal portions extending parallel to the main axis and being offset relative to each other according to a transverse axis, which is orthogonal to the main axis.

4. The battery module according to claim 3, wherein:
when the battery module is in a closed configuration, the terminal portions are geometrically carried by a same connection plane, which is parallel to the main axis and parallel to the transverse axis,
the cover comprises two extensions, each extension being associated with a respective passage,
each extension provides a conduit, which extends from the associated passage parallel to the main axis when the battery module is in a closed configuration, the terminal portion opening through the considered passage being at least partially received in the associated conduit,
the two conduits are open according to a same connection direction, the connection direction being orthogonal to the connection plane, so as to allow an electrical connection on each of the terminal portions according to the connection direction.

5. The battery module according to claim 4, wherein:
each terminal portion comprises an end, the ends of the terminal portions being aligned, relative to each other, according to the transverse axis,
each extension presents a lug, which extends in projection, from the rest of the extension, within the corresponding conduit, each lug being interposed between the extension and the corresponding terminal portion according to the connection direction, each lug presses against the corresponding terminal portion,
the lugs are aligned according to the transverse axis.

6. The battery module according to claim 4, wherein:
each terminal portion comprises an end presenting a terminal bulge, which is provided in projection relative to the rest of the corresponding terminal portion and extends according to the connection direction, each terminal bulge being configured to press against the associated contact pad,
each extension presents a terminal protrusion, which is provided in projection relative to the rest of the corresponding extension according to the connection direction, each terminal protrusion being aligned, according to the main axis, with the terminal bulge of the corresponding terminal portion.

7. A control unit for an electrical circuit breaker, the control unit comprising:
one example of the battery module according to claim 1, and
a casing, which is made of an insulating material and in which a housing for receiving the battery module is provided, the housing being provided recessed from the front plane and opening onto the front face according to the depth axis,
wherein:
the control unit comprises two contact pads, which are arranged in a bottom of the housing,
the two output tabs are configured to be electrically connected to a respective contact pad when the control unit is in the assembled configuration.

8. The control unit according to claim 7, wherein:
the battery module is configured to receive a battery presenting two poles located on opposite faces of the battery,
the two conductive elements include a first element, which is carried by the cover, and a second element, which is carried by the envelope,
the output tabs each comprise a terminal portion presenting generally a straight blade shape,
when the battery module is in a closed configuration, the two terminal portions open from the cavity through passages, which are provided in the cover, the two terminal portions extending parallel to the main axis and being offset relative to each other according to a transverse axis, which is orthogonal to the main axis,
wherein:
when the battery module is in a closed configuration, the terminal portions are geometrically carried by a same connection plane, which is parallel to the main axis and parallel to the transverse axis,
the cover comprises two extensions, each extension being associated with a respective passage,
each extension provides a conduit, which extends from the associated passage parallel to the main axis when the battery module is in a closed configuration, the terminal portion opening through the considered passage being at least partially received in the associated conduit,
the two conduits are open according to a same connection direction, the connection direction being orthogonal to the connection plane, so as to allow an electrical connection on each of the terminal portions according to the connection direction, and wherein:
the housing comprises a bottom wall, in which openings are provided, the contact pads being located on a side opposite the housing relative to the bottom wall,
when the control unit is in the assembled configuration, each extension and the associated terminal portion pass through the corresponding opening, the terminal portion being pressed against the corresponding contact pad.

9. The control unit according to claim 8, wherein:
the openings present an IP2x protection index as defined in the IEC 60529:2013 standard.

10. The control unit according to claim 8, wherein:
each terminal portion comprises an end presenting a terminal bulge, which is provided in projection relative to the rest of the corresponding terminal portion and extends according to the connection direction, each terminal bulge being configured to press against the associated contact pad,
each extension presents a terminal protrusion, which is provided in projection relative to the rest of the corresponding extension according to the connection direction, each terminal protrusion being aligned, according to the main axis, with the terminal bulge of the corresponding terminal portion,
and wherein:
each terminal protrusion is configured to, during an insertion movement of the battery module into the battery housing, presses against a contour of the corresponding opening, so as to guide each extension and the associated terminal portion during the passage through the opening and to prevent the terminal bulge of the considered terminal portion from hitting the contour of the opening.

11. An electrical circuit breaker, comprising:
a breaker unit, comprising at least one actuator and a breaker device triggerable by means of the actuator,
one example of the control unit according to claim 7,
wherein:
the breaker unit provides a receptacle, which opens onto a frontal face of the breaker unit,
the control unit is received in the receptacle of the breaker unit in an assembled configuration of the electrical circuit breaker, where the control unit is configured to control the actuator, so as to trigger the breaker device.
